(19) United States
(12) Patent Application Publication
(10) Pub. No.: US 2005/0116616 A1
(43) Pub. Date: Jun. 2, 2005

(54) Organic electroluminescence display device, method of manufacturing an organic electroluminescence display device, large sized organic electroluminescence display device, and electronic apparatus

(76) Inventor: Hiroshi Koeda, Suwa-shi (JP)

Correspondence Address: HARNESS, DICKEY & PIERCE, P.L.C., P.O. BOX 828, BLOOMFIELD HILLS, MI, 48303, US

(21) Appl. No.: 10/980,980

(22) Filed: Nov. 4, 2004

(30) Foreign Application Priority Data
Nov. 7, 2003 (JP) 2003-378144

(51) Int. Cl. H05B 33/14

(52) U.S. Cl. 313/500; 313/504

(57) ABSTRACT

An organic electroluminescence display device is provided including an electroluminescence substrate equipped with an electroluminescence element for emitting light and a thin film transistor substrate equipped with a thin film transistor for controlling current supplied to the electroluminescence element. The electroluminescence substrate and the thin film transistor substrate are disposed facing each other. A first controller which controls the thin film transistor is disposed between the electroluminescence substrate and the thin film transistor substrate.

### RELATED APPLICATIONS

This application claims priority to Japanese Patent Application No. 2003-378144 filed Nov. 7, 2003 which is hereby expressly incorporated by reference herein in its entirety.

### BACKGROUND

1. Field of the Invention

The present invention relates to an organic electroluminescence display device, a method of manufacturing an organic electroluminescence display device, a large size organic electroluminescence display device, and an electronic apparatus.

2. Related Art

In recent years, display panels using organic electroluminescence elements (hereinafter referred to as organic EL elements) have been able to display high quality images by driving the organic EL elements by thin film transistors (hereinafter referred to as TFTs). Especially, since organic EL elements are solid elements, the display panels using organic EL elements are relatively easy to be sealed at their edges in comparison with display panels using liquid crystals, and therefore, are suitable for forming (tiling) large sized panels by arranging a plurality of display panels in parallel.

When tiling the display panels as described above, it has been difficult to prepare places for mounting driver ICs which control TFTs for driving the organic EL elements. When tiling the display panels in two vertical lines by two horizontal lines, the drivers for the horizontal and vertical directions can be mounted on the edge surfaces along the periphery of the display panels. However, when tiling the display panels in three or more vertical lines by three or more horizontal lines, it has been difficult to mount the driver ICs and so on in the periphery of the display panel (which is positioned in the center) so as to hide the joints from view.

Accordingly, to cope with the above problem, a method has been proposed (e.g., Japanese Unexamined Patent Publication No. 2002-207436), in which a polyimide substrate is used as one substrate of the display panel, a number of through-holes are formed in the polyimide substrate, and the driver ICs and TFTs are electrically connected and mounted via the through-holes.

Since organic EL elements have problems with moisture-resistance, display panels using organic EL elements are required to have gas-tight properties. Although the polyimide substrate is used as one substrate in Japanese Unexamined Patent Publication No. 2002-207436 described above, the polyimide substrate may not offer a sufficient gas-barrier performance, and accordingly, the organic EL elements may be damaged.

Further, if a substrate having a different coefficient of thermal expansion from the polyimide substrate, such as a glass substrate, is used as the other substrate, the gas-tight property of the display panel may be broken due to the difference in the coefficient of thermal expansion of each substrate resulting in damage to the organic EL elements.

Further, even if a glass substrate having a gas-barrier property is used as one substrate described above, it is difficult to form a number of through-holes in the glass substrate, and therefore, it problematically takes a long time to form them.

The present invention aims to solve the above problems, and has an advantage of providing an organic EL display device, a method of manufacturing an organic EL display device, a large size electroluminescence display device, and an electronic apparatus equipped with the organic EL display device capable of preventing damage to the organic EL elements as well as of being easily tiled without bringing the joints between the organic EL devices into clear view.

### SUMMARY

To achieve the above advantage, an organic electroluminescence display device according to the present invention comprises an electroluminescence substrate equipped with an electroluminescence element for emitting light, a thin film transistor substrate equipped with a thin film transistor for controlling current supplied to the electroluminescence element, the electroluminescence substrate and the thin film transistor substrate being disposed facing each other, and a first control means which controls the thin film transistor and is disposed between the electroluminescence substrate and the thin film transistor substrate.

In other words, the organic electroluminescence display device has the first control means for controlling the thin film transistor disposed between the electroluminescence substrate and the thin film transistor substrate. Accordingly, a number of signals input to the thin film transistor can be integrally input to the first control means, thus decreasing the number of paths for inputting signals. As a result, the possibility that air including moisture invades from the paths for inputting the signals can be reduced, thus preventing the organic EL element from being easily damaged.

Further, since the first control means is disposed between the electroluminescence substrate and the thin film transistor substrate, the first control means can also be disposed in an area other than the periphery of the organic electroluminescence display device, such as for example, an area inside the image display area. Accordingly, the wiring length between the control means and the thin film transistor can be shortened, thus the shift of response time caused by the transfer time of signals to the thin film transistor can also be reduced.

To realize the above configuration, more specifically, a second control means for controlling the first control means can also be disposed between the electroluminescence substrate and the thin film transistor substrate.

According to the above configuration, the second control means for controlling the first control means is disposed between the electroluminescence substrate and the thin film transistor substrate. Accordingly, a number of signals input to the first control means can be integrally input to the second control means, thus further decreasing the number of paths for inputting signals. As a result, the number of paths through which air including moisture can invade may be further decreased, thus preventing the organic EL element from being easily damaged.

To realize the above configuration, more specifically, a photodiode for receiving an optical signal for externally controlling light emission of the electroluminescence element can also be disposed between the electroluminescence substrate and the thin film transistor substrate.

According to this configuration, by using optical signals as the signals for controlling light emission of the electroluminescence element, and receiving the signals by the photodiode, the number of paths through which air including moisture can invade may be further decreased, thus preventing the organic EL elements from being easily damaged.

Further, since the wiring for transmitting the signals for controlling light emission of the electroluminescence element can be omitted, thus making it needless to consider the wiring, an arrangement of a plurality of organic electroluminescence display devices becomes easier.

A first large size organic electroluminescence display device according to the present invention comprises a plurality of organic electroluminescence display devices described above according to the present invention set in array.

In other words, in the first large size organic electroluminescence display device according to the present invention, since the organic electroluminescence display device has the first control means and so on disposed between the electroluminescence substrate and the thin film transistor substrate, a number of the organic electroluminescence display devices can be arranged without any spaces therebetween and without being blocked by the first control means. Accordingly, the tiling can be easily realized without bringing the joints between the plurality of the organic electroluminescence display devices into clear view.

A second large size organic electroluminescence display device according to the present invention comprises a plurality of organic electroluminescence display devices arranged in a plurality of lines, wherein any one of the plurality of organic electroluminescence display devices surrounded with the others is the organic electroluminescence display device described above as according to the present invention.

In other words, in the second large size organic electroluminescence display device, the organic electroluminescence display device according to the present invention is disposed at a position where the organic electroluminescence display device is surrounded by other organic electroluminescence display devices and accordingly it is difficult to arrange the organic electroluminescence display devices without a space. Therefore, the joints between the organic electroluminescence display devices located in the image display area can be obscured.

A method of manufacturing an organic electroluminescence display device according to the present invention is a method of manufacturing an organic electroluminescence display device having an electroluminescence substrate equipped with an electroluminescence element for emitting light and a thin film transistor substrate equipped with a thin film transistor for controlling current supplied to the electroluminescence element, comprising (a) the step of providing the electroluminescence substrate, (b) the step of forming the thin film transistor and first control means on the thin film transistor substrate, the first control means controlling the thin film transistor, and (c) the step of bonding the thin film transistor substrate with the electroluminescence substrate so that the first control means faces the electroluminescence substrate.

In other words, in the method of manufacturing an organic electroluminescence display device according to the present invention, the thin film transistor and the first control means for controlling the thin film transistor are formed on the thin film transistor substrate in the step (b), and the thin film transistor substrate is bonded with the electroluminescence substrate so that the first control means faces the electroluminescence substrate in the step (c). Accordingly, the signals for controlling the electroluminescence element can be integrally input to the first control means in the organic electroluminescence display device, and then distributed therefrom to the thin film transistors. Since the number of signal input paths entering the organic electroluminescence display device can be decreased to reduce the possibility that air charged with moisture invades from the paths, the organic electroluminescence element can be prevented from being easily damaged.

To realize the above configuration, more specifically, in the step (b), the thin film transistor can be transferred to the thin film transistor substrate after forming the first control means on the thin film transistor substrate.

According to this configuration, a thin film transistor previously formed in another step is transferred and mounted on the thin film transistor substrate to which the first control means has been provided. Therefore, the first control means can be formed in the thin film transistor substrate, namely in a layer lower than the surface on which the thin film transistor is mounted.

To realize the above configuration, more specifically, a step of forming a second control means for controlling the first control means on the thin film transistor substrate can also be provided.

According to this configuration, since the second control means for controlling the first control means is formed on the thin film transistor substrate, the signals input to the first control means can be integrally input to the second control means, and then distributed therefrom to the first control means. Since the number of signal input paths can be further decreased to decrease the number of paths through which air charged with moisture invades, the electroluminescence element can be prevented from being easily damaged.

To realize the above configuration, more specifically, a step of forming a photodiode for receiving an optical signal for controlling light emission of the electroluminescence element on the thin film transistor substrate can also be provided.

According to this configuration, since the photodiode for receiving an optical signal for controlling light emission of the electroluminescence element is formed on the thin film transistor substrate, the signals can be input without forming any paths through which air charged with moisture invades. Thus, the electroluminescence element can be more surely prevented from being easily damaged.

An electronic apparatus according to the present invention uses the organic electroluminescence display device according to the present invention or the organic electroluminescence display device manufactured by the method of manufacturing the organic electroluminescence device according to the present invention.

Since the electronic apparatus according to the present invention uses the organic electroluminescence display device according to the present invention or the organic electroluminescence display device manufactured by the method of manufacturing the organic electroluminescence device according to the present invention, damage to the EL elements can be prevented, and the tiling can be easily realized without bringing the joints between the organic electroluminescence display devices into clear view.

### BRIEF DESCRIPTION OF THE DRAWINGS

FIG. 1 is a plan view showing an embodiment of an organic EL device according to the present invention.

FIG. 2 is a partial exploded perspective view of the organic EL device according to the present invention.

FIG. 3 is a partial cross-sectional view of a substantial part of the organic EL device according to the present invention.

FIGS. 4A through 4D are schematic cross-sectional views showing steps of a manufacturing method of an organic EL device according to the present invention.

FIGS. 5A through 5C are schematic cross-sectional views showing steps of a manufacturing method of an organic EL device according to the present invention.

FIGS. 6A and 6B are schematic cross-sectional views showing steps of a manufacturing method of an organic EL device according to the present invention.

FIG. 7 is a perspective view showing an embodiment of an electronic apparatus according to the present invention.

### DETAILED DESCRIPTION

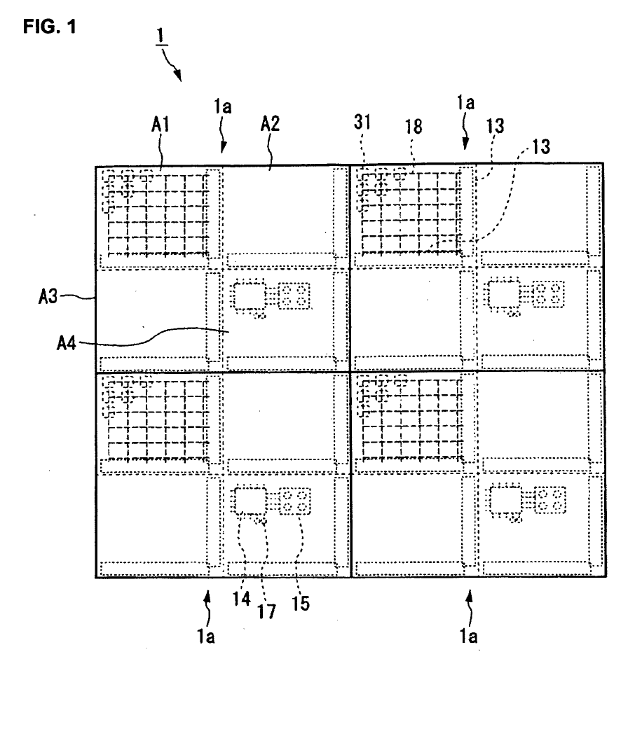

Hereinafter, an organic electroluminescence display device (hereinafter referred to as an organic EL display device), a large size organic EL display device, and a method of manufacturing an organic EL device according to the present invention are described with reference to the accompanying drawings, FIGS. 1 through 6B.

Note that the scale size of each illustrated member is appropriately altered so that each member is shown large enough to be recognized in the drawings.

Organic EL Device

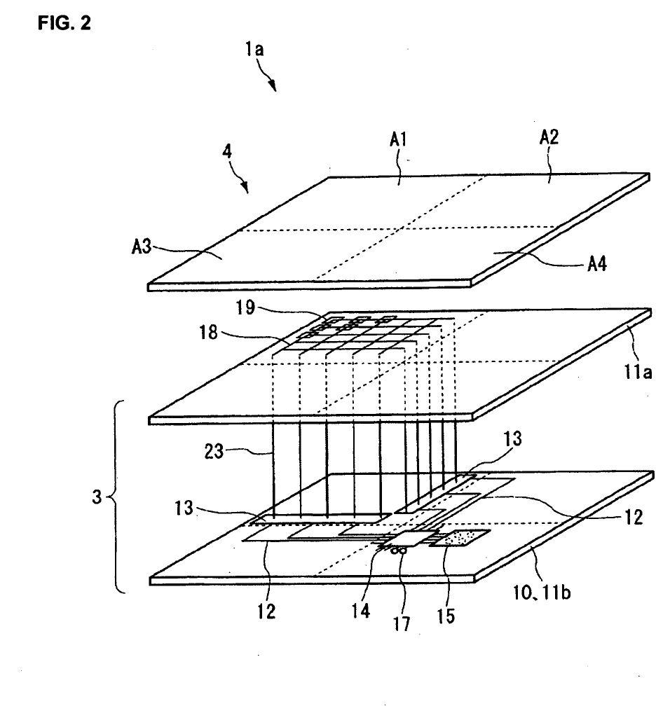

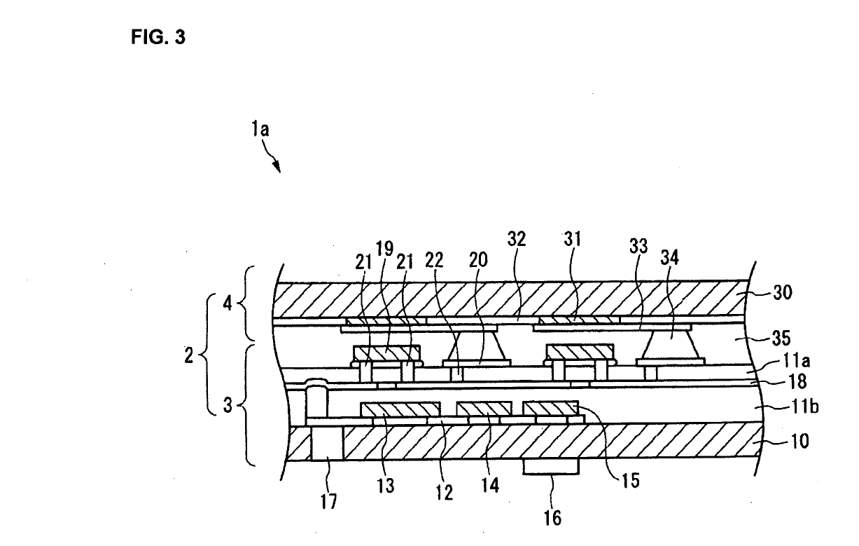

FIG. 1 is a plan view showing an overall configuration of the organic EL display device according to the present invention. FIG. 2 is an exploded perspective view of the organic EL display according to the present invention. FIG. 3 is a partial cross-sectional view of a substantial part of the organic EL display device according to the present invention. Note that in FIGS. 1 and 2, a repeated structure is shown by one representative part, and the other parts are omitted.

As shown in FIG. 1, the organic EL display device (a large size electroluminescence display device) 1 is formed by arranging smaller organic EL devices (electroluminescence display devices) 1a in a matrix of two vertical lines by two horizontal lines. Note that, although the matrix of two vertical lines by two horizontal lines can be adopted as the arrangement pattern of the organic EL display devices 1a, other various arrangement patterns such as a matrix of thee vertical lines by three horizontal lines or a matrix of three vertical lines by four horizontal lines can also be adopted.

As shown in FIGS. 2 and 3, the organic EL display device 1a is configured to have at least a body of stacked substrates 2. The body of stacked substrates 2 is configured to have a TFT substrate (a thin film transistor substrate) 3 and an organic EL substrate (an organic electroluminescence substrate) 4 bonded to each other via an inter-substrate conducting section 34 described below.

The TFT substrate 3 is roughly configured to have a wiring substrate 10 having a light transmissive property, a second inter-layer insulating layer 11b, and a first inter-layer insulating layer 11a stacked in this order.

A second wiring 12 is formed on the upper surface of the wiring substrate 10, and a driver IC (a first control means) 13, control LSI (a second control means) 14, and photodiode array (photodiodes) 15 are arranged on the second wiring 12. The second inter-layer insulating layer 11b is formed so as to cover the driver ICs 13. Further, on the lower surface (the opposite surface to the surface on which the driver ICs 13 and so on are disposed) of the wiring substrate 10 and at a position facing the photodiode array 15 via the wiring substrate 10, there is disposed a surface emitting laser array 16 for transmitting clock pulses or RGB image signals.

The photodiode array 15 is electrically connected to the control LSI 14 via the second wiring 12, and a power supply section 17 for supplying current to the organic EL elements (organic electroluminescence elements) 31 is also connected to the control LSI 14. The photodiode array 15 is composed of four photodiodes respectively receiving light signal of clock pulses, R (red), G (green), and B (blue) image signals. The signal input to the photodiode array 15 is then input to the control LSI 14, and distributed and output to the corresponding driver ICs 13.

Note that, although the photodiode array 15 can be composed of four photodiodes, the number of photodiodes is not particularly limited and only one photodiode can form the photodiode array.

On the upper surface of the second inter-layer insulating layer 11b, there is formed a first wiring 18 for forming a gate wiring, a source wiring and so on. The first inter-layer insulating layer 11a is formed so as to cover the first wiring 18. On the upper surface of the first inter-layer insulating layer 11a, there are formed TFTs (thin film transistors) 19 for driving the organic EL elements 31, and inter-substrate connecting electrodes 20. The TFTs 19 and the first wiring 18 are electrically connected via TFT connecting sections 21, and the inter-substrate connecting wiring 20 and the first wiring 18 are electrically connected via electrode connecting sections 22. The TFT connecting sections 21 is formed corresponding to a terminal pattern of the TFTs, and is composed of bumps formed by an electroless plating process and conductive paste formed on the bumps by a coating process. The conductive paste is a material including, for example, anisotropic conductive particles (ACP). Further, the first wiring 18 and the second wiring 12 are electrically connected to each other in wiring connecting sections 23.

A display area of the organic EL display device 1a is divided into display regions of two vertical lines by two horizontal lines, A1, A2, A3, and A4, and two driver ICs 13 are disposed for each of the display regions. Each of the driver ICs 13 is electrically connected to the first wiring 18 functioning as the gate wiring and the first wiring 18 functioning as the source wiring, and controls light emission of the organic EL elements 31 by controlling the TFTs 19. Note that the driver ICs 13 are electrically connected to the control LSI 14 through the second wiring 12, and control signals for the TFTs 19 from the control LSI 14 are input thereto through the second wiring 12.

As shown in FIG. 3, the organic EL substrate 4 is composed of a transparent substrate 30 through which the emitted light is transmitted, the organic EL elements 31, an insulating film 32, and a cathode 33.

Note that the organic EL element 31 comprises an anode composed of transparent metal such as ITO, a hole injection/transfer layer, and an organic EL member, and emits light when an electron hole generated in the anode and an electron generated in the cathode are combined in the organic EL member. Note that, as a detailed structure of such an organic EL element, conventional technologies can be adopted. Further, an electron injection/transfer layer can be formed between the organic EL element 31 and the cathode 33.

Further, inter-substrate conducting sections 34 for conductively connecting the inter-substrate connecting electrodes 20 with the cathodes 33 and a sealing section (not shown in the drawings) for sealing the periphery of the TFT substrate 3 and the organic EL substrate 4 are provided between the TFT substrate 3 and the organic EL substrate 4, and a space between the TFT substrate 3 and the organic EL substrate 4 is filled with inactive gas 35.

The inter-substrate conducting section 34 is made of silver paste, and is pressed to be deformed when the TFT substrate 3 and the organic EL substrate 4 are bonded to each other as described below. Note that the inter-substrate conducting section 34 is not necessarily in a paste form, and can be any material(s) having conductivity and flexibility such as a silver material, and a desired material can be adopted as the conductive material.

As the inactive gas 35, a known gas can be adopted, and a nitrogen (N₂) gas is adopted in the present embodiment. Rare gases such as Ar are preferably used as alternatives, and mixed gases can also be used as long as they have inactive properties. The inactive gas 35 is encapsulated in the step of bonding the TFT substrate 3 with the organic EL substrate 4 described below.

Note that the material filled in the space between the TFT substrate 3 and the organic EL substrate 4 is not necessarily limited to a gaseous matter, and can be an inactive liquid.

The sealing section, which is a region composed of an adhesive such as a sealing resin and is provided in the periphery of the TFT substrate 3 and the organic EL substrate 4, functions to adhere the TFT substrate 3 with the organic EL substrate 4 and to seal the space between the TFT substrate 3 and the organic EL substrate 4.

Note that, although the sealing section can be composed of the sealing resin, it can also be composed of a so-called sealing cap, or alternatively, any configuration preventing matters causing degradation of the organic EL elements 31 from invading are preferably adopted. Further, a moisture absorbent for absorbing moisture which degrades the organic EL elements 31 can be provided between the TFT substrate 3 and the organic EL substrate 4.

According to the above configuration, since the driver ICs 13 for controlling the TFTs 19 and the control LSI 14 are disposed inside the TFT substrate 3, a number of signals entering the TFTs 19 can be integrally input to the control LSI 14, thus reducing the paths through which the above signals enter inside the organic EL display device 1a. Accordingly, the possibility that air including moisture invades from the paths for inputting the above signals can be reduced, thus preventing the organic EL elements 31 from being easily damaged.

Further, by using optical signals as the above signals, and receiving the signals by the photodiode array 15, the paths through which air including moisture can invade may be further reduced, thus preventing the organic EL elements 31 from being easily damaged.

Further, since the driver ICs 13 are disposed inside the TFT substrate 3, the driver ICs 13 can also be arranged in the image display area of the organic EL display device 1a. Accordingly, the wiring length between the driver ICs 13 and the TFTs 19 can be shortened, thus the shift of response time caused by the transfer time of signals to the TFTs 19 can also be reduced. Further, since the wiring resistances can be reduced, the power consumption of the organic EL display device 1 and 1a can be suppressed.

Further, since the driver ICs 13 are disposed inside the TFT substrate 3, the organic EL display devices 1a can be arranged without any spaces therebetween and without being blocked by the driver ICs 13. Accordingly, the tiling can be easily realized without bringing the joints of the plurality of the organic EL display devices 1a into clear view.

Further, by using the photodiode array 15 as the receiver of the above signals, the wiring for transferring the above signals can be omitted. Accordingly, it becomes needless to consider the wiring, and it becomes easier to arrange a plurality of organic EL display devices 1a.

Method of Fabricating an Organic EL Device

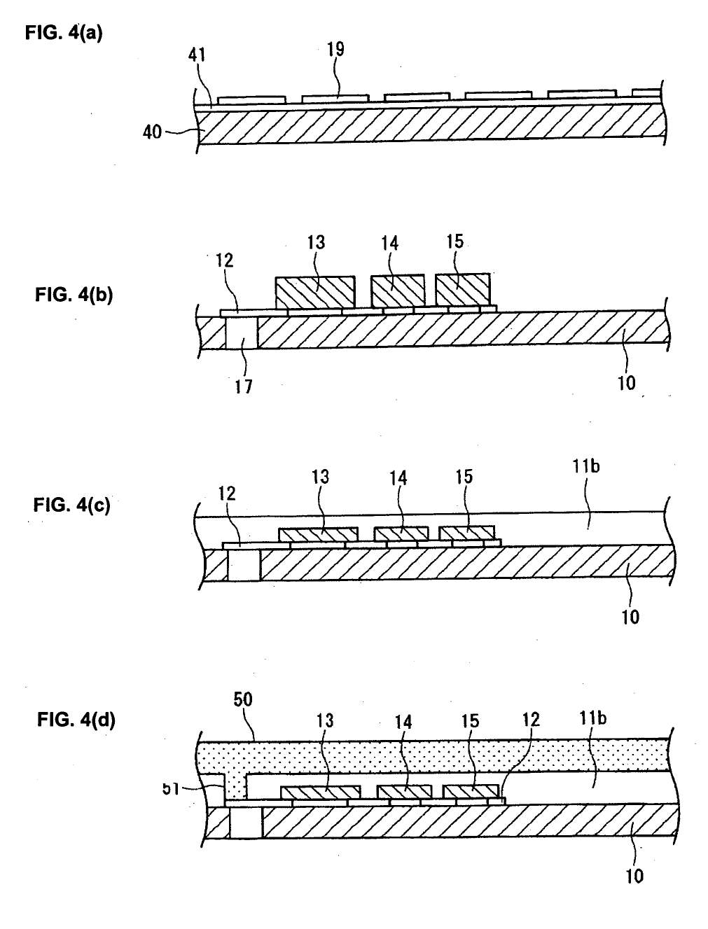

A fabrication (manufacturing) method of the organic EL display device 1a shown in FIG. 1 is hereinafter described with reference to FIGS. 4A through 6(B).

The fabrication method of the organic EL display device 1a is composed mainly of the step of forming the organic EL substrate (the first step), the step of forming the TFT substrate (the second step), the step of bonding the TFT substrate with the organic EL substrate (the third step), and each of the steps is executed in the order described above. Note that, although each step of the manufacturing method of the organic EL display device 1a can be executed in the above order, the order of the steps can be altered if necessary, or the procedures in each step described below can be altered if necessary.

In the present embodiment, SUFTLA (Surface Free Technology by Laser Ablation) (registered trade mark) technology is utilized to transfer the TFT and so on. Note that other known technologies can be adopted as the technology utilized to transfer the TFT and others.

Step of Forming the Organic EL Substrate

In the step of forming the organic EL substrate, the organic EL element 31, the insulating film 32, and the cathode 33 are formed on the transparent substrate 30 in this order. The organic EL elements 31, the insulating film 32, and the cathode 33 are formed using conventional materials and known technologies, and accordingly, the detailed descriptions thereof are omitted here.

Note that, the step of forming the organic EL substrate can be executed independently from the step of forming the TFT substrate, and therefore, may be executed parallel to the step of forming the TFT substrate.

Step of Forming the TFT Substrate

The step of forming the TFT substrate is composed of the step of forming TFTs, the step of mounting the driver ICs, and the step of transferring the TFTs. Hereinafter, these steps are described.

Note that the step of forming TFTs can be executed independently from the step of mounting the driver ICs, and therefore, can also be executed parallel to the step of mounting the driver ICs.

Step of Forming the TFTs

Firstly, with reference to FIG. 4A, the step of forming the TFTs 19 on a base substrate (forming substrate) 40 is described.

In this step, as shown in FIG. 4A, a delamination layer 41 is initially formed on the base substrate 40, and then a plurality of the TFTs 19 is arranged and then formed on the delamination layer 41. The TFTs 19 are arranged with a predetermined interval so that a predetermined one of the TFTs 19 can be easily selected in a later step.

Note that since the manufacturing method of the TFTs 19 adopts known technologies including a high-temperature process, the descriptions thereof are omitted, and the base substrate 40 and the delamination layer 41 are described in detail.

The base substrate 40 is a member used for forming the TFTs 19 in the present step, but not a component of the organic EL device 1. Specifically, a translucent heat-resistant substrate such as a quartz glass which can withstand 1000° C. is preferably used, but substrates other than the quartz glasses, such as heat-resistant glasses such as a soda glass, Corning 7059, Nippon Electric Glass OA-2, or the like can also be used.

In the delamination layer 41, the exfoliation (hereinafter referred to as “intra-layer delamination” or “interfacial delamination”) is caused by irradiation with laser beams or the like inside the delamination layer 41 or the interfacial surface thereof. The delamination layer 41 is composed of amorphous silicon (a-Si) including hydrogen (H). Since hydrogen is included, hydrogen (gas) is generated by irradiation of the laser beam to generate inner pressure inside the delamination layer 41, thus promoting the intra-layer delamination or the interfacial delamination. The content of hydrogen is preferably greater than about 2 at %, and further preferably in a range of 2 at % through 20 at %.

Note that since the function of the delamination layer 41 is to cause the intra-layer delamination or the interfacial delamination in response to irradiation of the laser beam or the like, the composition thereof is not limited to the above, and can be a material causing the intra-layer delamination or the interfacial delamination by creating ablation by the light energy, those causing delamination by a gas generated by vaporizing an ingredient with the light energy, or a material causing the intra-layer delamination or the interfacial delamination by a gas generated by vaporizing the composing material itself.

For example, silicon dioxide, silicate compounds, nitride ceramics such as silicon nitride, aluminum nitride, or titanium nitride, organic polymeric materials (in which the interatomic bond is broken by irradiation with light beams), and metals such as Al, Li, Ti, Mn, In, Sn, Y, La, Ce, Nd, Pr, Gd, or Sm, or alloys including at least one of these metals can be used.

As a fabrication method of the delamination layer 41, CVD processes, in particular a low-pressure CVD process or a plasma CVD process can be used.

Note that, in case the delamination layer 41 is composed of other materials, any processes capable of forming the delamination layer 41 to a uniform thickness can be selectively used in accordance with various conditions such as the composition or the thickness of the delamination layer 41. For example, various vapor deposition processes such as a CVD (including MOCCVD, low-pressure CVD, ECR-CVD) process, an evaporation process, a molecular beam deposition (MB) process, a sputtering process, an ion doping process, or a PVD process, various plating processes such as an electroplating process, a dipping plating process, or an electroless plating process, coating processes such as a Langmuir-Blodgett (LB) process, a spin coat process, a spray coat process, or a roll coat process, various printing processes, a transfer process, an inkjet process, a powder-jet process, and so on can be used. Further, two or more of these processes can be used in combination. Further, in case the delamination layer 41 is formed with ceramics by a sol-gel process, or with an organic polymeric material, a coating process, in particular a spin coat process, is preferably used to form the film.

Step of Mounting the Driver IC

The step of forming the driver IC 13, the control LSI 114, and the photodiode array 15 on the wiring substrate 10 is hereinafter described with reference to FIGS. 4B, 4C, and 4D.

As shown in FIG. 4B, after forming the second wiring 12, the driver IC 13, the control LSI 14, and the photodiode array 15 are formed on the wiring substrate 10, and then the second inter-layer insulating layer 11b is formed thereon.

The wiring substrate 10 is provided with a through-hole by a drill or the like, and the power supply section 17 is formed in the through-hole. The second wiring 12 is arranged so that the power supply section 17 and the control LSI 14 are electrically connected to each other.

As a method of forming the second wiring 12, known technologies such as a photolithography process can be adopted.

Further, a dispersion liquid in which fine metallic particles are dispersed in a carrier fluid (medium) can be deposited on the wiring substrate 10 using a droplet ejection process (an inkjet process). As a material for composing the second wiring 12 described above, low electrical resistance materials such as Al or Al alloys (Al—Cu alloy or the like) are preferably adopted.

As shown in FIG. 4C, the driver IC 13, the control LSI 14, and the photodiode array 15 are mounted on the second wiring 12. Subsequently, the driver IC 13, the control LSI 14, and the photodiode array 15 are ground to a thickness of about 50 μm. By grinding the driver IC 13, the control LSI 14, and the photodiode array 15, the mounting space thereof, and particularly the space in the thickness direction can be reduced, thus enabling the organic EL display device 1 to be lower-profiled and down-sized.

After mounting the driver IC 13 and so on, the second inter-layer insulating layer 11b made of acrylic resin or polyimide resin or the like is formed on the entire surface of the wiring substrate 10. As shown in FIG. 4D, the second inter-layer insulating layer 11b is cured while being stamped by a planarizing mold 50. The planarizing mold 50 is equipped with a protruded section 51, by which the through-hole is formed in the second inter-layer insulating layer 11b. The through-hole penetrates the second inter-layer insulating layer 11b, and exposes the second wiring 12 on the bottom thereof. Further, since the surface of the planarizing mold 50 facing the second inter-layer insulating layer 11b is formed to have superior evenness, the upper surface of the second inter-layer insulating layer 11b stamped therewith also has superior evenness.

Note that the second inter-layer insulating layer 11b can be formed with highly accurate evenness using a liquid-phase process such as a spin coat process, and then the through-hole can be formed in the second inter-layer insulating layer 11b by an exposure via a mask or a photolithography process.

Step of Transferring the TFT

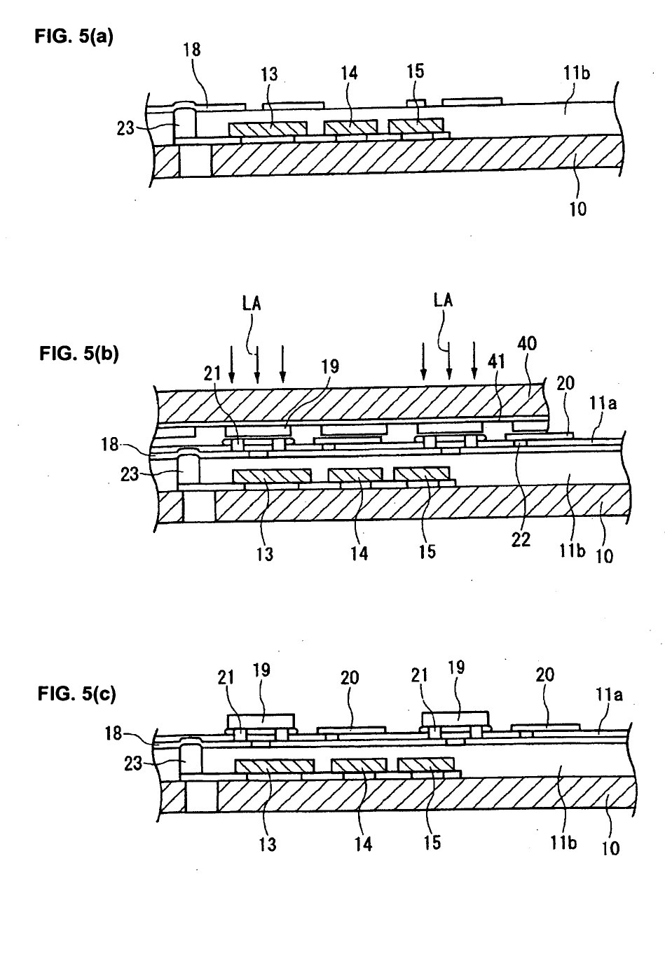

The step of forming the TFTs 19 on the wiring substrate 10 is now described with reference to FIGS. 5A, 5B, 5C, and 5D.

In this step, after forming the first wiring 18 on the second inter-layer insulating layer 11b of the wiring substrate 10, the first inter-layer insulating layer 11a is then formed thereon, and the TFTs 19 and inter-substrate connecting electrodes 20 are subsequently formed.

As shown in FIG. 5A, a wiring connecting section 23 for electrically connecting the second wiring 12 and the first wiring 18 to each other is formed in the through-hole of the second inter-layer insulating layer 11b, thus the first wiring 18 and the second wiring 12 are electrically connected with each other. Subsequently, the first wiring 18 is formed on the second inter-layer insulating layer 11b. As a method of forming the first wiring 18, a photolithography process or the like can be adopted as is the case with the second wiring 12. Further, the dispersion liquid of fine metallic particles can be deposited on the second inter-layer insulating layer 11b using a droplet ejection process (an inkjet process). As a material for composing the first wiring 18, low electrical resistance materials such as Al or Al alloys (Al—Cu alloy or the like) are preferably adopted.

After forming the second wiring 12, as shown in FIG. 5B, the first inter-layer insulating layer 11a made of acrylic resin, polyimide resin, or the like is formed on the entire surface of the second inter-layer insulating layer 11b. By using a liquid-phase process such as a spin coat process, the first inter-layer insulating layer 11a can be formed as an inter-layer insulating film with highly accurate evenness. Further, openings for forming TFT connecting sections 21 and electrode connecting sections 22 are formed in the first inter-layer insulating layer 11a by an exposing process via a mask or a photolithography process.

Subsequently, the TFT connecting sections 21 for electrically connecting the first wiring 18 with the TFTs 19 are formed using an electroless plating process. The TFT connecting sections 21 are so-called bumps.

In the case of using the electroless plating process, Ni—Au bumps are formed as the TFT connecting sections 21. Further, a solder or a Pb free solder such as a Sn—Ag—Cu solder or the like can be deposited on the Ni—Au bumps by a screen printing process or a dipping process to form the bumps.

Subsequently, the inter-substrate connecting electrodes 20 are formed using a known film forming method. For example, as vapor-phase processes, various processes used for semiconductor manufacturing processes such as a CVD process, a sputtering process, an evaporation process, an ion plating process or the like can be used.

Further, the inter-substrate connecting electrodes 20 can be formed using a liquid-phase process. In this case, a dispersion liquid made of fine metallic particles and a carrier fluid mixed with each other is adopted as a material liquid. As a specific liquid-phase process, a spin coat process, a slit coat process, a dip coat process, a spray coat process, a roll coat process, a curtain coat process, a printing process, a droplet ejection process, or the like can be used.

Then, as shown in FIG. 5B, the wiring substrate 10 described above is bonded with the base substrate 40 to transfer the TFTs 19 to the wiring substrate 10.

Firstly, the base substrate 40 and the wiring substrate 10 are bonded with each other with an electrically conductive paste including anisotropic conductive particles (ACP) coated between the TFTs 19 and the TFT connecting sections 21.

Then, only the portions coated with the electrically conductive paste on the reverse surface (a surface on which no TFT is formed) of the base substrate 40 is locally irradiated with a laser beam LA. Accordingly, the bonding forces between atoms or molecules in the delamination layer 41 are weakened, and hydrogen forms molecules to be separated from the crystal bond, namely the bonding forces between the TFTs 19 and the base substrate 40 completely disappear to enable the TFTs located in the portions irradiated with the laser beam LA to be easily detached therefrom.

Subsequently, as shown in FIG. 5C, the TFTs 19 are removed from the base substrate 40 and simultaneously transferred to the wiring substrate 10 by peeling the base substrate 40 from the wiring substrate 10. Note that terminals of the TFTs 19 are connected to the first wiring 18 via the TFT connecting sections 21 and the electrically conductive paste.

Step of Bonding the TFT Substrate With the Organic EL Substrate

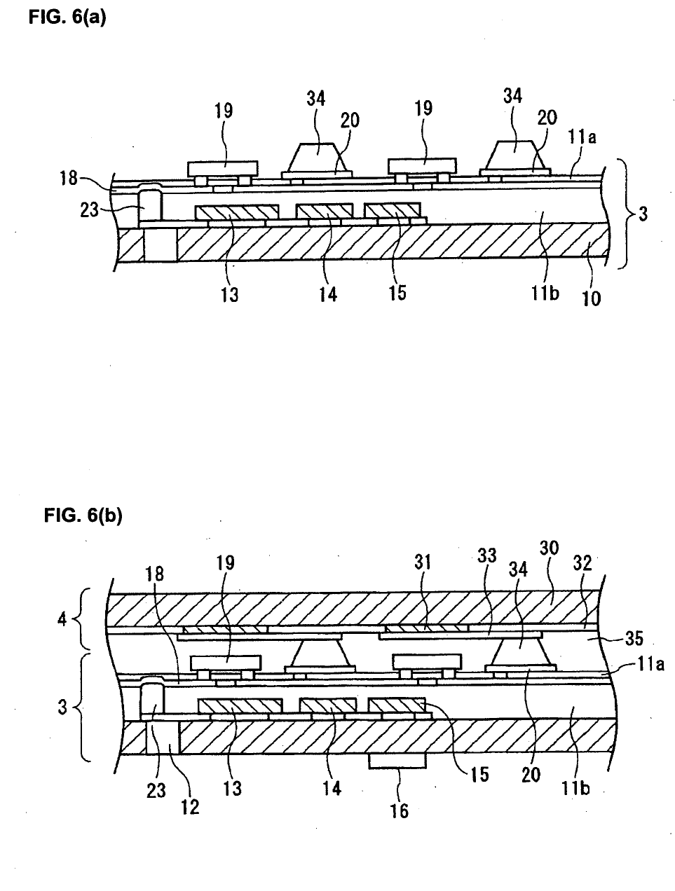

The step of finally forming the organic EL device 1a by bonding the TFT substrate 3 described above with the organic EL substrate 4 is now described with reference to FIGS. 6A and 6B.

Firstly, as shown in FIG. 6A, the inter-substrate conducting sections 34 for electrically connecting the inter-substrate connecting electrode 20 with the organic EL elements 31 are formed on the TFT substrate 3. The inter-substrate conducting section 34 is a silver paste formed on the inter-substrate connecting electrode 20, and as a method of forming the inter-substrate conducting section 34, known process such as a screen printing process or the like can be used.

Then, as shown in FIG. 6B, after positioning the TFT substrate 3 so as to correspondingly face the organic EL substrate 4, the TFT substrate 3 and the organic EL substrate 4 are bonded and then pressed to each other. Accordingly, the upper surfaces of the inter-substrate conducting sections 34 contact the cathodes 33, then the inter-substrate conducting sections 34 are pressed against the cathodes 33, thus the inter-substrate connecting electrodes 20 and the cathodes 33 are electrically connected via the inter-substrate conducting sections 34. As a result, the organic EL elements 31 and the TFTs 19 are electrically connected via the inter-substrate conducting sections 34 and so on.

In this condition, the inactive gas 35 is filled in between the TFT substrate 3 and the organic EL substrate 4, and as shown in FIG. 6B, the peripheries of the TFT substrate 3 and the organic EL substrate 4 are sealed to complete the organic EL device 1a.

Note that as a method of filling the inactive gas 35 and sealing the substrates, a method in which the inactive gas is filled in and the substrates are sealed after bonding the TFT substrate 3 with the organic EL substrate 4, and a method in which the TFT substrate 3 and the organic EL substrate 4 are bonded with each other and then sealed in a chamber providing an inactive gas environment can be used.

The organic EL device 1a manufactured by the manufacturing method described above is a top-emission type of organic EL device, having the cathode 33, the organic EL member, the hole injection/transfer layer, and the anode disposed in the organic EL substrate in this order from the TFT substrate 3 side, in which the emitted light is emitted from the transparent substrate 30.

As described above, the TFTs 19, the driver ICs 13, and the control LSI 14 are formed on the TFT substrate 3 in the step of forming the TFT substrate, and the TFT substrate 3 and the organic EL substrate 4 are bonded in the step of bonding the TFT substrate with the organic EL substrate so that the driver ICs 13 and the control LSI 14 face the organic EL substrate 4.

Therefore, the signals for controlling the organic EL elements 31 can be integrally input to the control LSI 14 inside the organic EL display device 1a, and then distributed to the TFTs 19 via the driver ICs 13. Since the number of signal input paths entering the organic EL display device 1a can be decreased to reduce the possibility that air charged with moisture invades from the paths, the organic EL element 31 can be prevented from being easily damaged.

Electronic Apparatus

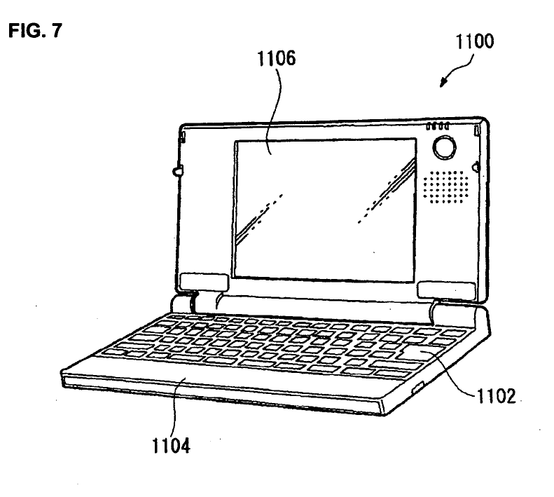

An embodiment of an electronic apparatus equipped with the organic EL display device described above is hereinafter described. FIG. 7 is a perspective view showing the configuration of a mobile type personal computer (an information processing device) equipped with a display device according to the embodiment described above. In the drawing, the personal computer 1100 is composed of a main body section 1104 and a display device unit equipped with the organic EL device described above as a display device 1106. Therefore, an electronic apparatus equipped with a display section having good luminous characteristics can be provided.

Note that in addition to the examples described above, mobile phones, wristwatch electronic apparatuses, liquid crystal televisions, video cassette recorders of viewfinder types or direct monitor types, car navigation devices, pagers, personal digital assistants, electric calculators, word processors, work stations, picture phones, POS terminals, electronic papers, apparatuses equipped with a touch panel and so forth can be cited as further examples thereof. The electro-optic device of the present invention can also be applied to the display section of the electronic apparatus described above.

Note that the scope of the present invention is not limited to the embodiments described above, and various modifications can be made within the scope and spirit of the present invention.

For example, although the present invention is described in the form of an application to the organic EL display device in the above embodiments, the present invention is not limited to the organic EL device, and can also be applied to other various display devices such as a reflective liquid crystal display device.

Further, although the application to the configuration of mounting the control LSI 14 inside the TFT substrate 3 is described in the above embodiments, the control LSI 14 is not limited to this configuration of being mounted inside the TFT substrate 3, and can also be applied to other various configuration such as a configuration in which the control LSI 14 is disposed outside the organic EL display device 1.

Further, although the application using the surface emitting laser array 16 for inputting the external signals is described, the application is not limited to this signal input configuration of using the surface emitting laser, and can include other various signal input configurations such as those using an optical fiber.

Still further, although the application to the configuration of using the power supply section 17 provided in the through-hole formed in the wiring substrate 10 for supplying the organic EL elements 31 with current for emitting light is described in the above embodiments, an application to a configuration other than the configuration using the power supply section 17, using an induction coil for supplying the organic EL elements 31 with current can also be employed. According to this configuration, since no through-holes need be formed in the wiring substrate 10, the possibility of damaging the organic EL elements 31 can be further reduced.

1. An organic electroluminescence display device comprising:
an electroluminescence substrate equipped with an electroluminescence element for emitting light;
a thin film transistor substrate equipped with a thin film transistor for controlling current supplied to the electroluminescence element, the electroluminescence substrate and the thin film transistor substrate being disposed facing each other; and
first control means which controls the thin film transistor and is disposed between the electroluminescence substrate and the thin film transistor substrate.

2. The organic electroluminescence display device according to claim 1, further comprising second control means which controls the first control means and is disposed between the electroluminescence substrate and the thin film transistor substrate.

3. The organic electroluminescence display device according to claim 1, further comprising a photodiode disposed between the electroluminescence substrate and the thin film transistor substrate and receiving an optical signal for externally controlling light emission of the electroluminescence element.

4. A large size organic electroluminescence display device comprising a plurality of organic electroluminescence display devices according to claim 1 set in an array.

5. A large size organic electroluminescence display device comprising a plurality of organic electroluminescence display devices arranged in a plurality of lines, wherein any of the plurality of organic electroluminescence display devices surrounded with others comprises the organic electroluminescence display device according to claim 1.

6. A method of manufacturing an organic electroluminescence display device having an electroluminescence substrate equipped with an electroluminescence element for emitting light and a thin film transistor substrate equipped with a thin film transistor for controlling current supplied to the electroluminescence element, comprising:
(a) providing the electroluminescence substrate;
(b) forming the thin film transistor and first control means on the thin film transistor substrate, the first control means controlling the thin film transistor; and
(c) bonding the thin film transistor substrate with the electroluminescence substrate so that the first control means faces the electroluminescence substrate.

7. The method of manufacturing an organic electroluminescence display device according to claim 6, wherein, in step (b), the thin film transistor is transferred to the thin film transistor substrate after forming the first control means on the thin film transistor substrate.

8. The method of manufacturing an organic electroluminescence display device according to claim 6, further comprising:
forming second control means on the thin film transistor substrate, the second control means controlling the first control means.

9. The method of manufacturing an organic electroluminescence display device according to claim 6, further comprising:
forming a photodiode on the thin film transistor substrate, the photodiode receiving an optical signal for controlling light emission of the electroluminescence element.

10. An electronic apparatus comprising the organic electroluminescence display device according to claim 1.

11. An organic electroluminescence display device comprising:
an electroluminescence substrate equipped with an electroluminescence element emitting light;
a thin film transistor substrate disposed facing the electroluminescence substrate, the thin film transistor substrate being equipped with a thin film transistor controlling current supplied to the electroluminescence element; and
a first controller disposed between the electroluminescence substrate and the thin film transistor substrate, the first controller controlling the thin film transistor.
